(19) United States
(12) Patent Application Publication
(10) Pub. No.: US 2023/0219200 A1
(43) Pub. Date: Jul. 13, 2023

(54) ELECTRIC SCREW DRIVER WITH CLUTCH AND ROTATIONAL SPEED CONTROLLING MODULE THEREOF

(71) Applicant: Lucent Innovation Co., Ltd., New Taipei City (TW)

(72) Inventors: Yueh Yang HU, New Taipei City (TW); Bo-Yi WU, New Taipei City (TW); Yun-Lun CHANG, New Taipei City (TW)

(21) Appl. No.: 18/068,059

(22) Filed: Dec. 19, 2022

(30) Foreign Application Priority Data
Jan. 10, 2022 (TW) 111100905

(51) Int. Cl. B25B 21/00; B25B 23/147

(52) U.S. Cl. CPC B25B 21/008; B25B 23/147

(57) ABSTRACT

A rotational speed controlling module includes an input unit, a first receiving unit, a second receiving unit, and a controlling unit. The input unit is to input a first target rotational speed value, a second target rotational speed value and a target number of turns. The first receiving unit is to receive a real-time rotational speed value from an electric screw driver with clutch. The second receiving unit is to receive a real-time number of turns. The controlling unit is to control real-time rotational speed value to decrease from the first target rotational speed value to the second target rotational speed value when the real-time number of turns reaches the target number of turns.

This application claims the benefit of Taiwan Patent Application Serial No. 111100905, filed Jan. 10, 2022, the subject matter of which is incorporated herein by reference.

### BACKGROUND OF THE INVENTION

### Field of the Invention

The invention relates to a device and a module, and more particularly to a clutch-type power transmission device and a rotational speed controlling module thereof.

### Description of the Prior Art

An electric screw driver provides a rotational driving force from an input shaft of a power source, in which a clutch-type power transmission assembly is utilized to output a rotational energy to a tool for rotating a rotational locking member such as a screw. Generally, the electric screw driver is applied to a torque lock of an equipment, a machine tool or any the like. By having the input shaft of the power source to provide the rotational driving force, human labor in rotation operation can be saved, time for locking can be shortened, and operation efficiency can be enhanced. It shall be explained that, in this conventional electric screw driver equipped with a clutch-type power transmission assembly, a torque detecting module is provided for examining a torque value.

Referring to FIG. 1, FIG. 1 illustrates schematically relationships of rotational speeds and torques with respect to numbers of turns in the art. As shown, after the conventional electric screw driver is activated, the real-time rotational speed value would accelerate from 0 to the maximum rotational speed RM; and, after the maximum rotational speed RM is reached, the rotational speed value of the conventional electric screw driver would be kept at the maximum rotational speed RM. At this time, the electric screw driver would be deemed as being operated at a full speed. Then, while hitting a preset target torque value TM, the electric screw driver would be turned into a disengagement state. Simultaneously, the real-time number of turns of the electric screw driver would reach a final number of turns LT. In the disengagement state, the real-time rotational speed value of the electric screw driver would turn zero from the maximum rotational speed RM, and the torque value would turn zero also from the target torque value TM.

Nevertheless, while the real-time rotational speed value reaches the maximum rotational speed RM, the time upon the screw would be short. Thus, the torque value detected by the torque detecting module would be definitely different to the real torque value applied at the screw. If the difference in between becomes larger, locking upon the screw would be affected. For example, if the real torque value upon the screw is far less than the detected torque value due to a phase lag, then the fastening of the screw would be highly concerned, and an unstable locking might be met. In order to avoid possible phase lag, a further high-level control element is required. Otherwise, it can be to reduce the real-time rotational speed value so as to extend the application time upon the screw, such that the detected torque value can approach much closer to the torque value at the screw. However, the high-level control element is expensive, and, if the real-time rotational speed value is absent-minded reduced, the electric screw driver may not be able to jump to the disengagement state from the engagement state. Namely, the real-time rotational speed value in the art can’t be arbitrarily adjusted to ensure a smooth jump from the engagement state to the disengagement state, and so the operation thereof would be lack of flexibility.

### SUMMARY OF THE INVENTION

In view that the conventional locking process may become unstable while the real-time rotational speed value is kept at the highest rotational speed, the difficulty of jumping from the engagement state to the disengagement state may be met upon when the real-time rotational speed value is reduced, and less flexibility in operation and some associated ill consequences may occur to fail the self-adjustment upon the real-time rotational speed value, accordingly it is an object of the present invention to provide a rotational speed controlling module to resolve at least one of the problems met in the art.

In accordance with the present invention, a rotational speed controlling module, connected in a communication manner with a clutch-type power transmission device, is to control a real-time rotational speed of the clutch-type power transmission device upon when the clutch-type power transmission device rotates a rotational locking member. The clutch-type power transmission device is operated to transmit in a real-time manner a real-time number of turns accumulated from a start-up and a real-time rotational speed value corresponding to the real-time rotational speed. The rotational speed controlling module includes an input unit, a first receiving unit, a second receiving unit and a control unit. The input unit is used for inputting a first target rotational speed value, a second target rotational speed value less than the first target rotational speed value and a target number of turns less than a lock-up turn number of the rotational locking member. The first receiving unit is used for receiving the real-time rotational speed value. The second receiving unit is used for receiving the real-time number of turns. The control unit, connected electrically with the input unit, the first receiving unit and the second receiving unit, is used for controlling the clutch-type power transmission assembly to maintain an operation at the real-time rotational speed corresponding to the first target rotational speed upon when the real-time rotational speed value reaches the first target rotational speed value, and for controlling the clutch-type power transmission assembly to decelerate so as to decrease the real-time rotational speed value from the first target rotational speed value to the second target rotational speed value upon when the real-time number of turns reaches the target number of turns.

In one embodiment of the present invention, the rotational speed controlling module further includes an adjustment unit connected electrically with the control unit. The adjustment unit is used for manipulatively adjusting an acceleration value of the clutch-type power transmission assembly, so as to adjust an acceleration time duration required for the real-time rotational speed value to vary from 0 to the first target rotational speed value.

In one embodiment of the present invention, the rotational speed controlling module further includes an adjustment unit connected electrically with the control unit. The adjustment unit is used for manipulatively adjusting a deceleration value of the clutch-type power transmission assembly, so as to adjust a deceleration time duration required for the real-time rotational speed value to vary from the first target rotational speed value to the second target rotational speed value.

In one embodiment of the present invention, the rotational speed controlling module further includes an alert unit connected electrically with the first receiving unit and the second receiving unit, and used for generating an alert message upon when the real-time number of turns triggers an alert condition.

In one embodiment of the present invention, the rotational speed controlling module further includes a setting unit connected electrically with the alert unit, and used for manipulatively setting an upper bound of turns and a lower bound of turns. The real-time number of turns triggers the alert condition whenever the real-time number of turns is greater than the upper bound of turns or less than the lower bound of turns.

In one embodiment of the present invention, the rotational speed controlling module further includes a display unit connected electrically with the first receiving unit and the second receiving unit, and used for displaying the real-time rotational speed value and the real-time number of turns.

In accordance with the present invention, a clutch-type power transmission device includes a clutch-type power transmission assembly, a sensor module and a rotational speed controlling module. The clutch-type power transmission assembly is used for rotating a rotational locking member. The sensor module is used for sensing a real-time rotational speed value and a real-time number of turns accumulated from a start-up, corresponding to a real-time rotational speed, after the clutch-type power transmission assembly is operated.

The rotational speed controlling module, connected in a communication manner with the sensor module, includes an input unit, a first receiving unit, a second receiving unit and a control unit. The input unit is used for inputting a first target rotational speed value, a second target rotational speed value less than the first target rotational speed value and a target number of turns less than a lock-up turn number of the rotational locking member. The first receiving unit is used for receiving the real-time rotational speed value. The second receiving unit is used for receiving the real-time number of turns. The control unit, connected electrically with the input unit, the first receiving unit and the second receiving unit, is used for controlling the clutch-type power transmission assembly to maintain an operation at the real-time rotational speed corresponding to the first target rotational speed upon when the real-time rotational speed value reaches the first target rotational speed value, and for controlling the clutch-type power transmission assembly to decelerate so as to decrease the real-time rotational speed value from the first target rotational speed value to the second target rotational speed value upon when the real-time number of turns reaches the target number of turns.

In one embodiment of the present invention, the clutch-type power transmission device further includes an adjustment unit connected electrically with the control unit. The adjustment unit is used for manipulatively adjusting an acceleration value of the clutch-type power transmission assembly, so as to adjust an acceleration time duration required for the real-time rotational speed value to vary from 0 to the first target rotational speed value.

In one embodiment of the present invention, the clutch-type power transmission device further includes an adjustment unit connected electrically with the control unit. The adjustment unit is used for manipulatively adjusting a deceleration value of the clutch-type power transmission assembly, so as to adjust a deceleration time duration required for the real-time rotational speed value to vary from the first target rotational speed value to the second target rotational speed value.

In one embodiment of the present invention, the clutch-type power transmission device further includes an alert unit and a setting unit. The alert unit, connected electrically with the first receiving unit and the second receiving unit, is used for generating an alert message upon when the real-time number of turns triggers an alert condition. The setting unit, connected electrically with the alert unit, is used for manipulatively setting an upper bound of turns and a lower bound of turns. The real-time number of turns triggers the alert condition whenever the real-time number of turns is greater than the upper bound of turns or less than the lower bound of turns.

As stated above, in the rotational speed controlling module and the clutch-type power transmission device provided by this disclosure, the input unit, the first receiving unit, the second receiving unit and the control unit are integrated to provide the control upon the real-time rotational speed value. In comparison to the prior art, while the real-time number of turns reaches the target number of turns in this disclosure, the real-time rotational speed value is controlled to decrease from the first target rotational speed value to the second target rotational speed value, such that the stability of the locking process can be improved. In addition, the second target rotational speed value can be self-adjusted so as to provide better operational flexibility. Further, since the second target rotational speed value has a lower bound, the jump of the clutch-type power transmission device from the engagement state to the disengagement state can be can be surely performed.

All these objects are achieved by the electric screw driver with a clutch and a rotational speed controlling module thereof described below.

### BRIEF DESCRIPTION OF THE DRAWINGS

The present invention will now be specified with reference to its preferred embodiment illustrated in the drawings, in which:

FIG. 1 illustrates relationships of the real-time rotational speed values and the torques with respect to the numbers of turns in the art;

FIG. 2 is a schematic view of an embodiment of the rotational speed controlling module in accordance with the present invention;

FIG. 3 illustrates relationships of the real-time rotational speed values and the torques with respect to the numbers of turns in the embodiment of FIG. 2;

FIG. 4 shows schematically comparisons between the present invention and the prior art;

FIG. 5 shows schematically the real-time rotational speeds with respect to the time in accordance with the present invention;

FIG. 6 shows schematically the lower bounds of rotational speeds with respect to the torques in accordance with the present invention; and

FIG. 7 is a schematic view of an embodiment of the clutch-type power transmission device in accordance with the present invention.

### DESCRIPTION OF THE PREFERRED EMBODIMENT

The invention disclosed herein is directed to an electric screw driver with a clutch and a rotational speed controlling module thereof. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

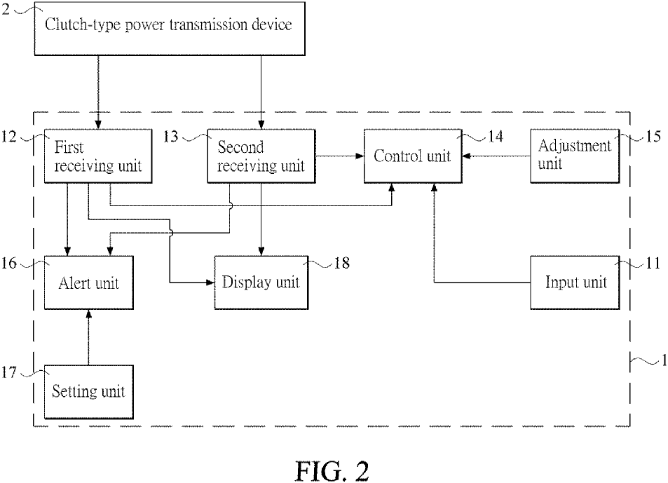

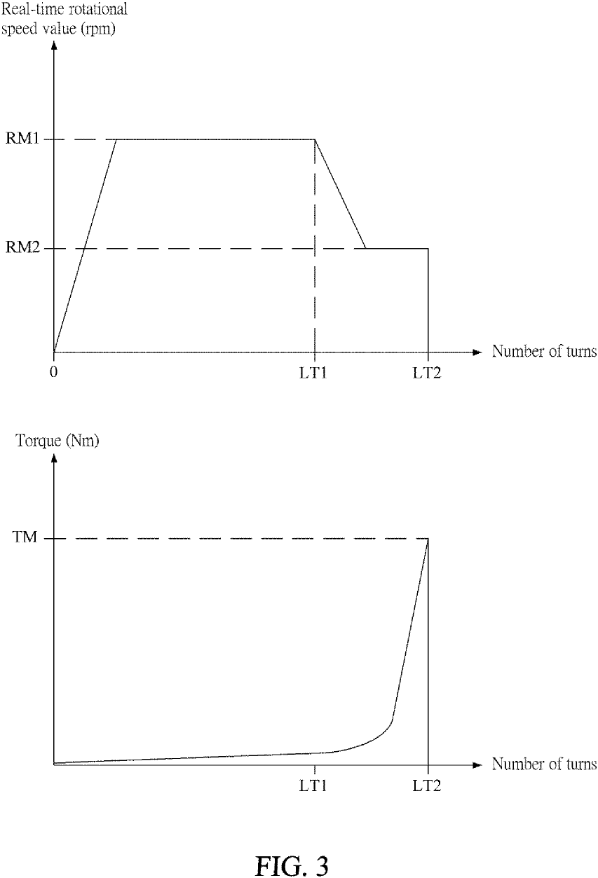

Refer to FIG. 2 and FIG. 3; where FIG. 2 is a schematic view of an embodiment of the rotational speed controlling module in accordance with the present invention, and FIG. 3 illustrates relationships of the real-time rotational speed values and the torques with respect to the numbers of turns in the embodiment of FIG. 2. As shown, this rotational speed controlling module 1 is connected in a communication manner with a clutch-type power transmission device 2, and includes an input unit 11, a first receiving unit 12, a second receiving unit 13 and a control unit 14.

The clutch-type power transmission device 2 is used to rotate a rotational locking member. Generally speaking, the clutch-type power transmission device 2 is an electric screw driver, and the rotational locking member is a screw. After the clutch-type power transmission device 2 is operated, a real-time number of turns, accumulated since the beginning of the operation and a real-time rotational speed value with respect to a corresponding real-time rotational speed are transmitted in a real-time manner.

The input unit 11 is used for inputting a first target rotational speed value RM1, a second target rotational speed value RM2 and a target number of turns LT1. The second target rotational speed value RM2 is less than the first target rotational speed value RM1, and the target number of turns LT1 would be less than a lock-up turn number of the rotational locking member. Practically, the lock-up turn number is a thread number of the screw, usually inputted by a user through the input unit 11.

The first receiving unit 12 is used for receiving the real-time rotational speed value. The second receiving unit 13 is used for receiving the real-time number of turns. The clutch-type power transmission device 2 would sense and generate correspondingly a real-time rotational speed value and a real-time number of turns. Namely, the first receiving unit 12 and the second receiving unit 13 are used to receive the aforesaid data only. In particular, the first receiving unit 12 and the second receiving unit 13 can utilize Bluetooth, Wi-Fi, RFID and the like wireless communication means to receive these data.

The control unit 14 is connected electrically with the input unit 11, the first receiving unit 12 and the second receiving unit 13. While the real-time rotational speed value reaches the first target rotational speed value RM1, the control unit 14 would control the clutch-type power transmission device 2 to perform the real-time rotational speed operation corresponding to the first target rotational speed value RM1. Upon when the real-time number of turns reaches the target number of turns LT1, the control unit 14 would control the clutch-type power transmission device 2 to decelerate so as to reduce the real-time rotational speed value from the first target rotational speed value RM1 down to the second target rotational speed value RM2.

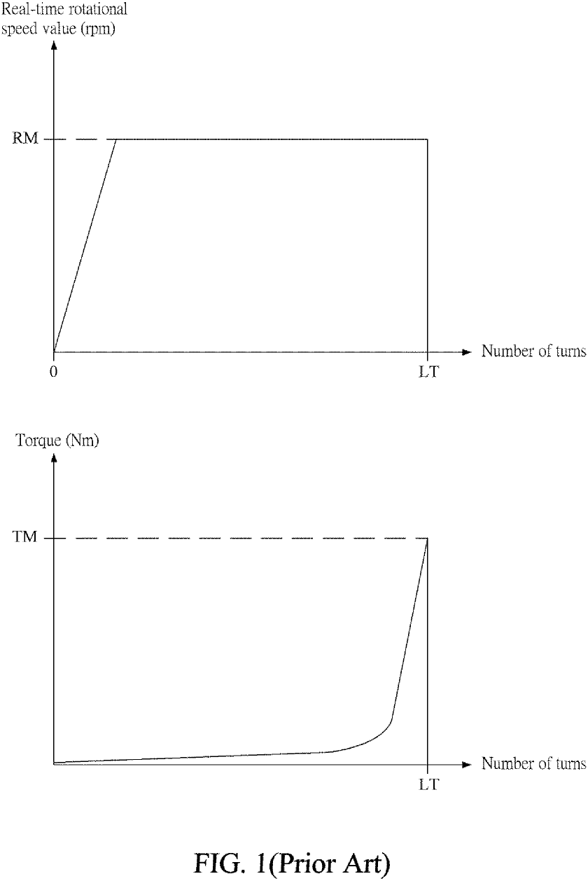

By comparing FIG. 1 to FIG. 3, at the moment when the real-time number of turns reaches the target number of turns LT1, the control unit 14 of this embodiment would control the clutch-type power transmission device 2 to decelerate so as to improve the stability of the locking process. In addition, in the illustrations of the torques with respect to the numbers of turns, after the clutch-type power transmission device 2 of this embodiment is decelerated, the torque value can still reach the target torque value TM gradually, and thus the problem of the clutch-type power transmission device 2 failing to jump from the engagement state to disengagement state would be resolved.

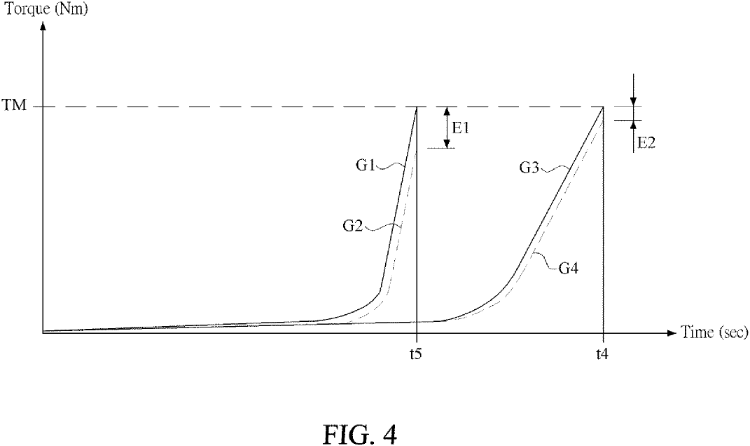

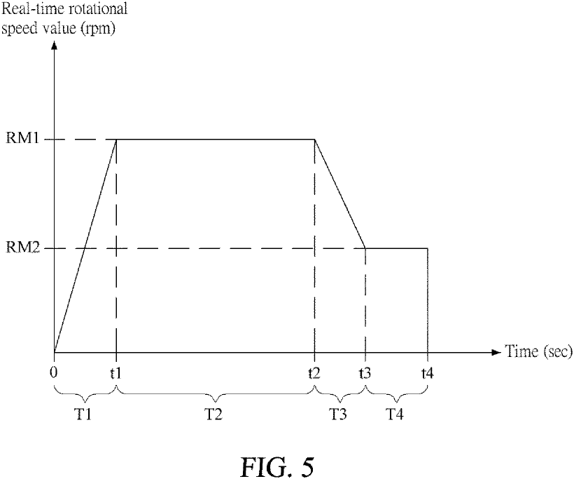

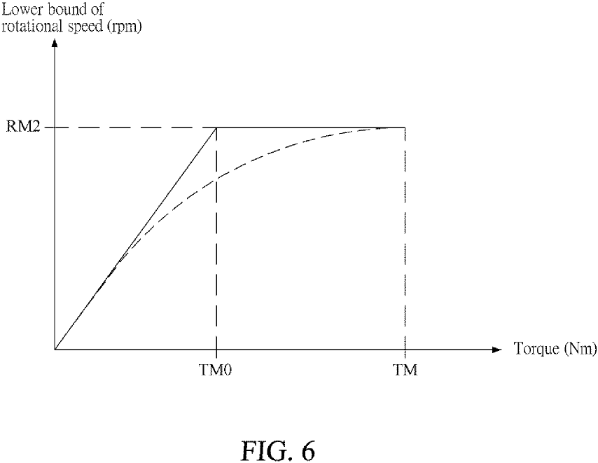

Then, refer to FIG. 2 to FIG. 6 together; where FIG. 4 shows schematically comparisons between the present invention and the prior art, FIG. 5 shows schematically the real-time rotational speeds with respect to the time in accordance with the present invention, and FIG. 6 shows schematically the lower bounds of rotational speeds with respect to the torques in accordance with the present invention. In this embodiment, the rotational speed controlling module 1 further includes an adjustment unit 15, an alert unit 16, a setting unit 17 and a display unit 18.

The adjustment unit 15, connected electrically with the control unit 14, is used for manipulatively adjusting an acceleration value of the clutch-type power transmission device 2, so as to adjust an acceleration time duration for the real-time rotational speed value to increase from 0 to the first target rotational speed value RM1. Referring to FIG. 5, a first time duration T1 formed from 0 to a first timing t1 is the acceleration time duration. The acceleration value adjusted by the adjustment unit 15 is a slope of the rotational speed varying from 0 to the first target rotational speed value RM1, and further to the first time duration T1. As the acceleration value grows larger, the slope would become larger, but the first time duration T1 would become shorter. On the other hand, as the acceleration value grows smaller, the slope would become smaller, but the first time duration T1 would become longer.

Within the second time duration T2 formed between the first timing t1 and the second timing t2, the control unit 14 would control the real-time rotational speed value of the clutch-type power transmission device 2 to maintain at the first target rotational speed value RM1.

In this embodiment, the target number of turns LT1 is corresponding to the second timing t2. Thus, when the second timing t2 is reached, the control unit 14 would control the clutch-type power transmission device 2 to decelerate so as to lower the real-time rotational speed value from the first target rotational speed value RM1 to the second target rotational speed value RM2.

The adjustment unit 15 can manipulatively adjust a deceleration value of the clutch-type power transmission device 2, such that a deceleration time duration for the real-time rotational speed value to be lowered from the first target rotational speed value RM1 to the second target rotational speed value RM2 can be adjusted. As shown in FIG. 5, the third time duration T3 formed between the second timing t2 and the third timing t3 is the deceleration time duration. The deceleration value to be adjusted by the adjustment unit 15 is a slope of the rotational speed varying from the first target rotational speed value RM1 to the second target rotational speed value RM2, further to the third time duration T3. Since the deceleration value is negative, thus, as the deceleration value becomes larger, the slope would be larger, and the third time duration T3 is extended. On the other hand, as the deceleration value becomes smaller, the slope would be smaller, and the third time duration T3 become narrower.

In this embodiment, to have the clutch-type power transmission device 2 to jump from the engagement state to the disengagement state, the instant torque value and the lower bound of rotational speed would present a relationship, as shown in FIG. 6. Namely, in order to jump to the real-time rotational speed value with respect to the instant torque value, the corresponding lower bound of rotational speed must be exceeded. To ensure the jump, the lower bound of rotational speed would be set to the solid line shown in FIG. 6. In the case that the torque value at the jump is less than the torque value TM0, the lower bound of rotational speed can be set to K times of the instant torque value, in which K is a proportional constant of the rotational speed to the torque. Practically, the setting shall be determined according to practical measurement or empirical doctrines. Generally, after the setting is complete, it can be further changed by the user. When the torque value is greater than or equal to the torque value TM0, the lower bound of rotational speed is the second target rotational speed value RM2. Thus, in this embodiment, even that the real-time rotational speed value is varied, it can be still assured that the real-time rotational speed value would be greater the lower bound of rotational speed corresponding to the instant torque value, such that the aforesaid problem of the prior art in failing to jump from the engagement state to the disengagement state can be resolved.

Within the fourth time duration T4 between the third timing t3 and the fourth timing t4, the real-time rotational speed value would be maintained at the second target rotational speed value RM2. In this embodiment, since the fourth timing t4 is the timing for the clutch-type power transmission device 2 to jump from the engagement state to the disengagement state, thus the real-time rotational speed value would be turned 0 from the second target rotational speed value RM2.

The alert unit 16, connected electrically with the first receiving unit 12 and the second receiving unit 13, is used to generate an alert message upon when the real-time number of turns hits an alert condition. The setting unit 17, connected electrically with the alert unit 16, is used to manipulatively set an upper bound of turns and a lower bound of turns. In this embodiment, the alert condition to be triggered by the real-time number of turns is a condition that the real-time number of turns is greater than the upper bound of turns or lower than the lower bound of turns. By adopting the real-time number of turns as the alert condition, more precise alert functions can be provided. However, due to the precision, the alert condition may be triggered frequently.

In addition, after the clutch-type power transmission device 2 is operated, a torque value and a time duration value can be transmitted in a real-time manner, and correspondingly the first receiving unit 12 and the second receiving unit 13 can be used to receive the torque value and the time duration value, respectively. While the torque value or the time duration value triggers the corresponding alert condition, the alert unit 16 would generate a corresponding alert message.

Further, the alert condition of the torque value can be an accepted torque limit. As the torque value goes beyond the accepted torque limit, the alert condition would be triggered. When the torque value is higher than an upper bound of the accepted torque limit, it implies that the clutch in the clutch-type power transmission device 2 would be unable to perform the jump, and the torque value would keep rising. When the torque value is lower than a lower bound of the accepted torque limit, it implies that an elastic fatigue may exist inside the clutch-type power transmission device 2. In this embodiment, the alert condition of the time duration value can be an accepted time duration. When the time duration value exceeds the accepted time duration, the alert condition would be triggered. In the present invention, the alert condition of the time duration value can be determined in accordance with practical needs.

The display unit 18, connected electrically with the first receiving unit 12 and the second receiving unit 13, is used to display the aforesaid real-time rotational speed value and real-time number of turns for users to observe or monitor.

It shall be explained that, in this embodiment, though the input unit 11, the adjustment unit 15 and the setting unit 17 are three separate units, the input unit 11, the adjustment unit 15 and the setting unit 17 can be integrated into the same operational interface, such that the first target rotational speed value RM1, the second target rotational speed value RM2, the target number of turns LT1, the acceleration value, the deceleration value, the upper bound of turns and the lower bound of turns can be conveniently inputted.

As shown in FIG. 4, the prior-art torques are compared to the corresponding torques of this embodiment with respect to the times. In this illustration, curve G1 stands for the detected torques in the art, curve G2 stands for the practical torques in the art, curve G3 stands for the detected torques in the embodiment of the present invention, and curve G4 stands for the practical torques in the embodiment of the present invention.

In this embodiment, since the rotational speed controlling module 1 spends more time to adjust the real-time rotational speed value upon the rotational locking member, thus the torques of curve G3 and curve G4 would turn zero at the fourth timing t4. On the other hand, since the real-time rotational speed value in the art is always kept at the maximum rotational speed RM, thus the application time upon the rotational locking member would be shorter, and so the torques of curve G1 and curve G2 would turn zero at the fifth timing t5 less than the fourth timing t4. Since the application time of the clutch-type power transmission device 2 of this embodiment upon the rotational locking member is longer, thus curve G3 and curve G4 would rise in a more smooth way than curve G1 and curve G2, and the detected torques would be also much closer than the practical torques, upon the rotational locking member. As shown, curve G1 and curve G2 present a phase difference E1 at the fifth timing t5, curve G3 and curve G4 present another phase difference E2 at the fourth timing t4, and the phase difference E2 is smaller than the phase difference E1.

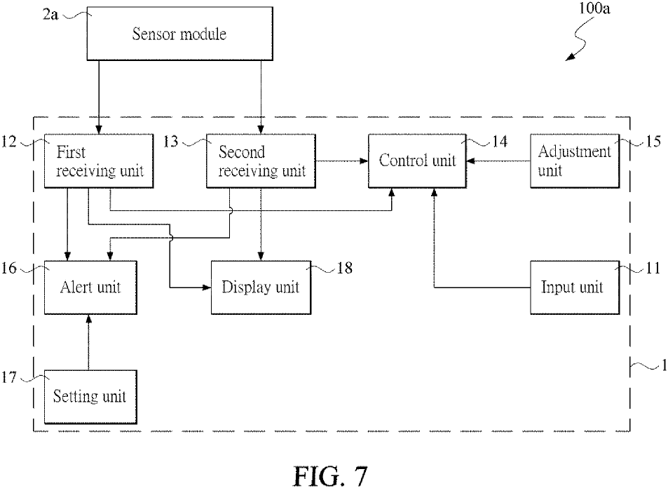

Finally, referring to FIG. 7, a schematic view of an embodiment of the clutch-type power transmission device in accordance with the present invention is shown. In this embodiment, the clutch-type power transmission device 100a includes a clutch-type power transmission assembly, a sensor module 2a and a rotational speed controlling module 1.

The clutch-type power transmission assembly is used for rotating a rotational locking member. Since this assembly is well known to the skill in the art and won’t produce any signal, thus any representation thereto is omitted in FIG. 7.

The sensor module 2a used for sensing a real-time rotational speed value, a real-time number of turns and a torque, accumulated from the start-up, corresponding to a real-time rotational speed after the clutch-type power transmission assembly is operated. Here, the real-time rotational speed value, the real-time number of turns and the torque are the same as those described in FIG. 2 to FIG. 6, and thus detail thereabout would be omitted herein.

The rotational speed controlling module 1, connected in a communication manner with the sensor module 2a, is used for receiving the real-time rotational speed value and the real-time number of turns, and includes an input unit 11, a first receiving unit 12, a second receiving unit 13 and a control unit 14. In this embodiment, the rotational speed controlling module 1 is the same as that in FIG. 2, and thus detail thereabout would be omitted herein.

In this embodiment, the rotational speed controlling module 1 further includes an adjustment unit 15, an alert unit 16, a setting unit 17 and a display unit 18. The adjustment unit 15, the alert unit 16, the setting unit 17 and the display unit 18 are also the same as corresponding units in FIG. 2, and thus detail thereabout would be omitted.

Hence, while in using the clutch-type power transmission device 100a provided in this embodiment, the rotational speed controlling module 1 can be conveniently used to input the first target rotational speed value, the second target rotational speed value and the target number of turns, and further to adjust the real-time rotational speed value, such that the stability of the locking process can be improved, and the flexibility of operation can be enhanced.

In summary, in the rotational speed controlling module and the clutch-type power transmission device provided by this disclosure, the input unit, the first receiving unit, the second receiving unit and the control unit are integrated to provide the control upon the real-time rotational speed value. In comparison to the prior art, while the real-time number of turns reaches the target number of turns in this disclosure, the real-time rotational speed value is controlled to decrease from the first target rotational speed value to the second target rotational speed value, such that the stability of the locking process can be improved. In addition, the second target rotational speed value can be self-adjusted so as to provide better operational flexibility. Further, since the second target rotational speed value has a lower bound, the jump of the clutch-type power transmission device from the engagement state to the disengagement state can be can be surely performed.

While the present invention has been particularly shown and described with reference to a preferred embodiment, it will be understood by those skilled in the art that various changes in form and detail may be without departing from the spirit and scope of the present invention.

What is claimed is:

1. A rotational speed controlling module, connected in a communication manner with a clutch-type power transmission device, being to control a real-time rotational speed of the clutch-type power transmission device upon when the clutch-type power transmission device rotates a rotational locking member, the clutch-type power transmission device being operated to transmit in a real-time manner a real-time number of turns accumulated from a start-up and a real-time rotational speed value corresponding to the real-time rotational speed, the rotational speed controlling module comprising:
an input unit, used for inputting a first target rotational speed value, a second target rotational speed value less than the first target rotational speed value and a target number of turns less than a lock-up turn number of the rotational locking member;
a first receiving unit, used for receiving the real-time rotational speed value;
a second receiving unit, used for receiving the real-time number of turns; and
a control unit, connected electrically with the input unit, the first receiving unit and the second receiving unit, used for controlling the clutch-type power transmission assembly to maintain an operation at the real-time rotational speed corresponding to the first target rotational speed upon when the real-time rotational speed value reaches the first target rotational speed value, and for controlling the clutch-type power transmission assembly to decelerate so as to decrease the real-time rotational speed value from the first target rotational speed value to the second target rotational speed value upon when the real-time number of turns reaches the target number of turns.

2. The rotational speed controlling module of claim 1, further including an adjustment unit connected electrically with the control unit, the adjustment unit being used for manipulatively adjusting an acceleration value of the clutch-type power transmission assembly, so as to adjust an acceleration time duration required for the real-time rotational speed value to vary from 0 to the first target rotational speed value.

3. The rotational speed controlling module of claim 1, further including an adjustment unit connected electrically with the control unit, the adjustment unit being used for manipulatively adjusting a deceleration value of the clutch-type power transmission assembly, so as to adjust a deceleration time duration required for the real-time rotational speed value to vary from the first target rotational speed value to the second target rotational speed value.

4. The rotational speed controlling module of claim 1, further including an alert unit connected electrically with the first receiving unit and the second receiving unit, and used for generating an alert message upon when the real-time number of turns triggers an alert condition.

5. The rotational speed controlling module of claim 4, further including a setting unit connected electrically with the alert unit, and used for manipulatively setting an upper bound of turns and a lower bound of turns, wherein the real-time number of turns triggering the alert condition whenever the real-time number of turns is greater than the upper bound of turns or less than the lower bound of turns.

6. The rotational speed controlling module of claim 1, further including a display unit connected electrically with the first receiving unit and the second receiving unit, and used for displaying the real-time rotational speed value and the real-time number of turns.

7. A clutch-type power transmission device, comprising:
a clutch-type power transmission assembly, used for rotating a rotational locking member;
a sensor module, used for sensing a real-time rotational speed value and a real-time number of turns accumulated from a start-up, corresponding to a real-time rotational speed, after the clutch-type power transmission assembly is operated; and
a rotational speed controlling module, connected in a communication manner with the sensor module, including:
an input unit, used for inputting a first target rotational speed value, a second target rotational speed value less than the first target rotational speed value and a target number of turns less than a lock-up turn number of the rotational locking member;
a first receiving unit, used for receiving the real-time rotational speed value;
a second receiving unit, used for receiving the real-time number of turns; and
a control unit, connected electrically with the input unit, the first receiving unit and the second receiving unit, used for controlling the clutch-type power transmission assembly to maintain an operation at the real-time rotational speed corresponding to the first target rotational speed upon when the real-time rotational speed value reaches the first target rotational speed value, and for controlling the clutch-type power transmission assembly to decelerate so as to decrease the real-time rotational speed value from the first target rotational speed value to the second target rotational speed value upon when the real-time number of turns reaches the target number of turns.

8. The clutch-type power transmission device of claim 7, further including an adjustment unit connected electrically with the control unit, the adjustment unit being used for manipulatively adjusting an acceleration value of the clutch-type power transmission assembly, so as to adjust an acceleration time duration required for the real-time rotational speed value to vary from 0 to the first target rotational speed value.

9. The clutch-type power transmission device of claim 7, further including an adjustment unit connected electrically with the control unit, the adjustment unit being used for manipulatively adjusting a deceleration value of the clutch-type power transmission assembly, so as to adjust a deceleration time duration required for the real-time rotational speed value to vary from the first target rotational speed value to the second target rotational speed value.

10. The clutch-type power transmission device of claim 7, further including:
an alert unit, connected electrically with the first receiving unit and the second receiving unit, used for generating an alert message upon when the real-time number of turns triggers an alert condition; and
a setting unit, connected electrically with the alert unit, used for manipulatively setting an upper bound of turns and a lower bound of turns, the real-time number of turns triggering the alert condition whenever the real-time number of turns is greater than the upper bound of turns or less than the lower bound of turns.
